(19) United States
(12) Patent Application Publication
(10) Pub. No.: US 2008/0102257 A1
(43) Pub. Date: May 1, 2008

(54) Paper-or Cardboard-Based Security Product

(76) Inventors: Outi Aho, Helsinki (FI); Lars Gadda, Espoo (FI); Tuomas Mustonen, Jyvaskya (FI); Bjorn Knuthammar, Linkoping (SE); Magnus Berggren, Vreta Kloster (SE); Thomas Kugler, Cambridge (GB); Bo Eriksson, Linkoping (SE); Petronella Norberg, Linkoping (SE); Tommi Remonen, Grankulla (FI)

Correspondence Address: HARNESS, DICKEY & PIERCE, P.L.C., P.O. BOX 8910, RESTON, VA, 20195, US

(21) Appl. No.: 10/551,936

(22) PCT Filed: Oct. 1, 2004
(86) PCT No.: PCT/FI04/00202

§ 371 Date: May 4, 2007

(30) Foreign Application Priority Data
Apr. 1, 2003 (FI) 20030492

(51) Int. Cl. B41M 3/14; B05D 5/12

(52) U.S. Cl. 428/211.1; 427/121

(57) ABSTRACT

A paper- or cardboard-based security product and a method of manufacturing it. The product comprises a paper or a cardboard which is equipped with an identifiable security symbol. According to the present invention, the security symbol comprises a layer in the product, one which consists of a synthetic, electrically conductive polymer, the conductivity of which has been changed locally to form an electrically conductive or, alternatively, electrically non-conductive figure. Furthermore, a figure indicating the security symbol has been fitted on the surface of the paper or the cardboard product. A security product according to the present invention can be produced simply by first applying a conductive polymer, for instance in a non-conductive form, onto a paper, after which an acidic figure is printed in such as way that the area below the figure becomes conductive. The figure can be detected and in this way it acts as a guarantee of authenticity for the product.

The present invention relates to a paper- or cardboard-based security product, according to the preamble of claim 1.

Generally, a product like this comprises a paper or a cardboard, which is equipped with a security symbol.

The present invention also relates to a method of manufacturing a security product according to the preamble of claim 12, and a method of confirming the authenticity of a security product, according to the preamble of claim 20.

Security symbols are used to demonstrate the authenticity of products. A paper watermark, which comprises an impressed figure made on the paper surface, is an example of a traditional security symbol. The purpose of the watermark is to demonstrate the origin of the paper. Envelopes and packages are equipped with seals and tear strips to ensure the integrity of the product. Also, bank notes have recently been equipped with hologram figures, security threads and the like to make counterfeiting more difficult. Product packages, such as plastic wrappings around CDs, have similar security symbols, too. Other electrical security symbols are microchips and induction coils, which comprise information in electronic form, from which the origin of the product can be established and confirmed.

A disadvantage of many modem security products is that those security symbols which are the most difficult to counterfeit are manufactured separately from the product, which means that the equipping of the product with the security symbol requires a separate stage of operation. In particular, this applies to paper and cardboard products, such as product wrappings and packing boxes, which are difficult to equip with, for instance, security symbols made of plastic, without it being possible for those symbols to be removed relatively unnoticed. Beyond that, it is often desirable to generate a mark, the information content of which could be modified and individualised by the manufacturer or the marketer. Furthermore, if the security sign is electronically readable, it is easier to automate administration of the product. In this case, the electronic security symbol can still be combined with other information, which is beneficial in the distribution channel and even to the consumer. The purpose of the present invention is to eliminate the disadvantages associated with known technology, and to generate a novel solution for producing security products. The present invention is based on the idea that the security symbol is created as a part of the manufacturing process of the product, and that the information content of the security symbol can be added mainly after the manufacturing of the base product, for instance when a desired surface figure is printed on the product.

According to the present invention, the security symbol comprises a layer in the product, which consists of a synthetic, electrically conductive polymer (hereafter also “conductive polymer”). The electrical conductivity of this layer can be locally changed so that it is electrically conductive or, alternatively, electrically non-conductive, in order to form a security symbol pattern or figure. In this case, the authenticity of the security product can be verified by identifying the electrical conductivity of the paper or the cardboard product at the point where the security symbol is located). Because the security symbol is mainly invisible (in some cases the security symbol can be established from the colour of the polymer, as described in more detail below), the security product is preferably fitted with a visual mark, which indicates the presence of the layer comprising conductive polymer. Thus, the security product according to the present invention comprises both a conductive polymer layer and a graphic figure or pattern to indicate this layer, and the information obtainable from this enables the verifying of the authenticity or origin of the product.

More specifically, the security product according to the present invention is characterized by what is stated in the characterizing part of claim 1.

The method of manufacturing a security product according to the present invention is, in turn, characterized by what is stated in the characterizing part of claim 12, and the method of establishing and confirming the authenticity of the security product according to the present invention is characterized by what is stated in the characterizing part of claim 20.

Considerable advantages can be achieved with the invention. Thus, a security product can be manufactured simply by first applying a conductive polymer for instance in non-conductive form on the paper. After this, an acidic figure is printed and, as a result, the area below the figure becomes conductive. A special property of the conductive polymer is that its conductivity depends on the pH value. For instance, polyaniline is conductive when the pH value is acidic. In contrast, when the pH value is alkaline, the polymer is not electrically conductive. By utilizing the dependence of the conductivity on the pH value, several applications can be generated and conductive figures can be formed in a controllable way. A simple way is to use some acidic material to print a desired figure, for instance a company logo, on the conductive polymer layer. In this case, the figure, being acidic, will be electrically conductive. The figure can be detected and thus, for instance, act as an authenticity guarantee for a document. The acidic figure to be printed can easily be modified, and thus it is possible to have an individualised figure.

The polymer layer forming the security symbol is preferably below the surface of the paper or the cardboard product. It can even be between two paper layers, and thus hidden. The conductive polymer can be placed between two paper webs, for instance together with the glue used in laminating, or a multi-layer product can be formed in a multi-layer headbox. In this case, an extra process stage can be avoided. When the conductive polymer is between the paper layers, it does not interfere with the today's main functions of the paper, and thus the paper or the cardboard surface, among other things, may still be printed on. When the conductive polymer is between the layers, several different functions can be achieved, and it is invisible to the consumer. The conductive polymer can be utilized, for example, to equip the product with additional information or to establish the authenticity of the product.

Contact with the conductive layer is not needed for measuring the conductivity of the security product and the security symbol. Non-contact measurement can be performed at a short distance, for instance using capacitive measurement. The opportunity for non-contact measurement is preferable in an application, according to the present invention, in which the conductive polymer is laminated below a fibre layer, for instance between fibre layers. The conductivity of conductive polymers, such as polyaniline, is always, regardless of its degree of purity, 4-6 decades lower than the copper conductivity level. However, the conductivity level of copper does not have to be achieved to give the paper or the cardboard additional properties. Manufacturing of conductive polymers is affordable, because the raw material is cheap, and clean rooms are not needed in the production processes. Good properties of conductive polymers are, among others, easily adjustable conductivity level i.e. sheet resistance, easily adjustable thickness and adjustable transparency of the conductive polymer layer, the mechanical properties of polymers (e.g. elasticity), and free choice of layer size to be formed.

A solution according to the present invention offers, besides the security symbols, the opportunity to add in the package information about, for instance, the content of the package and how the content should be used (directions for use). The limited surface area of the packages prevents printing of much additional information on the package. However, by using conductive polymer layers, these limitations can be eliminated.

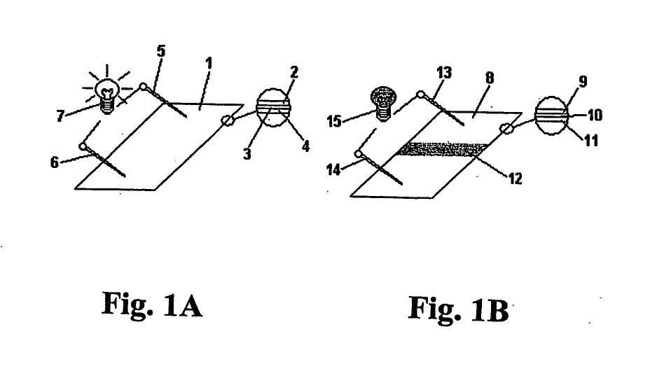

In the following, the invention will be examined in more detail with the help of a detailed explanation, together with the enclosed drawings. Using an axonometric illustration, FIGS. 1A and 1B show a multi-layer product according to the present invention, where a conductive polymer layer in the form of a stripe has been fitted between two non-conductive layers such that the paper is conductive along the stripe (FIG. 1A) but not conductive transversal to the stripe (FIG. 1B),

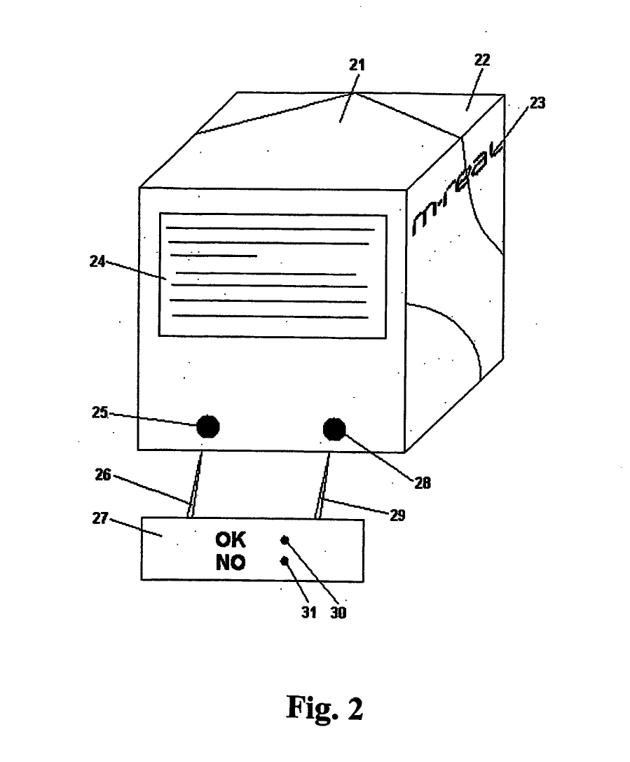

Using an axonometric illustration, FIG. 2 shows the first application of a package according to the present invention, where security symbols consisting of conductive polymer layers have been arranged on the side of the package,

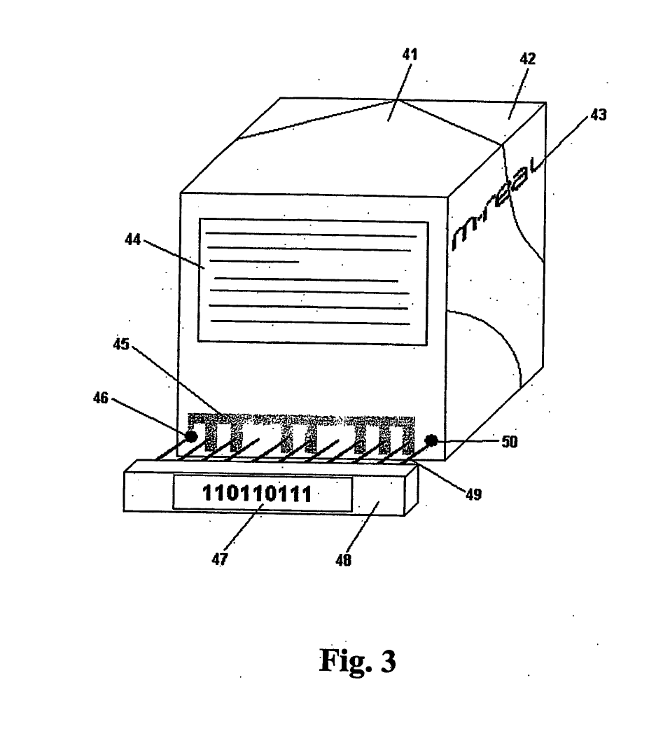

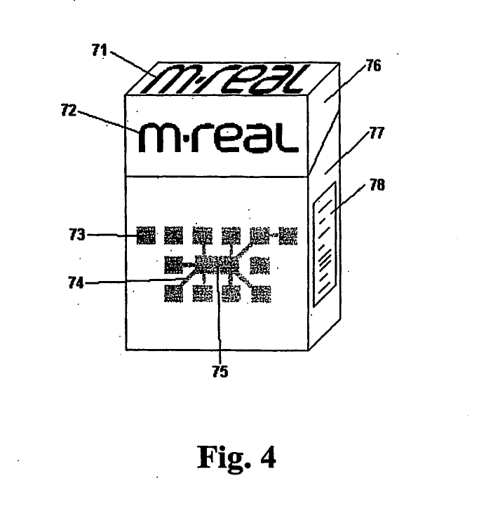

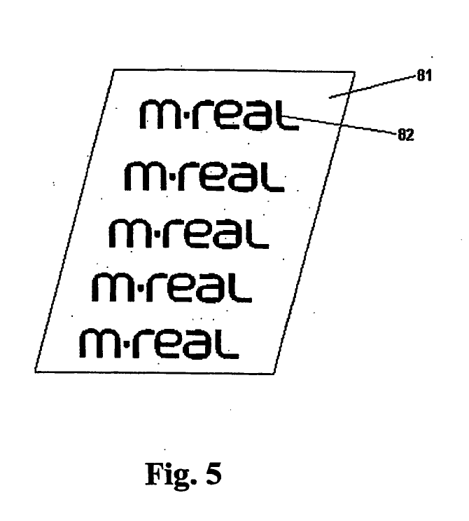

FIG. 3 shows, using an axonometric illustration, analogous to FIG. 2, another application of a package according to the present invention, where one security symbol has been designed as a comb-shaped/bar code-shaped figure that comprises digitized information, and FIG. 4 shows a package with a security symbol figure comprising binary information. FIG. 5 shows a fibre product which is equipped with security symbols shaped in the design of the deliverer's trade mark figures.

Papers and paper products, which comprise electrically conductive polymers, are well-known in patent literature. Thus, U.S. Pat. No. 5,421,959 presents a composite consisting of paper and an electrically conductive polymer suitable, for instance, for electrodes in primary or secondary batteries, or as an antistatic packing material or in products that protect against electromagnetic radiation. The composite is produced by immersing paper into a solution, which comprises an electrically conductive pre-stage (precursor) of a conjugated polymer which is then absorbed into the paper. After this, the paper is heat-treated in order to form the polymer onto the paper.

U.S. Pat. No. 5,211,810 presents a package suitable for microwave cooking, one which comprises fibres having electrically conductive polymer deposited on their surface. The polymerization is carried out in situ, in the presence of a strong mineral acid that is 1N hydrochloric acid. However, there is no reference in the publication about any electrical conductivity of fibres or any products made of such fibres.

In addition, in Published DE Patent Application No. 19826800 a security paper is described which comprises rod-shaped pigments or transparent polymers, which are electrically conductive. The pigments or the polymers can be mixed with the paper by adding them into the fibre slush in the headbox of the paper machine. In this way, they are uniformly distributed throughout the paper pulp.

The present invention generates a new type of paper or cardboard product, one with a security symbol that comprises conductive polymer. This security symbol is produced by fitting a layer into the paper or the cardboard product, one which comprises a synthetic and electrically conductive polymer. The electrical conductivity of this layer is locally changed to form a figure that is electrically conductive or, alternatively, electrically non-conductive. The figure forms the security symbol of the product and it can be used to verify the authenticity of the product. To identify the figure, the surface of the paper or the cardboard can be equipped with a figure indicating the presence of the security symbol.

The conductive polymer layer used in the present invention can be generated by some of the means described above, for instance by mixing polymers in the fibre slush, by absorbing polymer from a solution or a dispersion into the fibre web, or by polymerizing monomer into the fibres. The contents of the patents and the published patent application, namely U.S. Pat. No. 5,421,959, U.S. Pat. No. 5,211,810 and DE 19 826 800, are therefore incorporated by reference.

Preferably, a conductive polymer layer consists of a fibre matrix to which the electrically conductive polymers are attached so well that they cannot be washed away. In this way, the electrical conductivity of the product can be restored, even if it decreased temporarily, because the doping agent is dissolved in the wet cleaning. A fibre matrix like this can be generated by attaching the polymer to loose and porous natural fibres before they form a fibre web at the paper or the cardboard machine. The porous fibres are brought, for example, into firm contact with electrically conductive polymers in an aqueous intermediate agent, and the electrically conductive polymers are allowed to become attached to the fibres to produce a fibre composition, one where the polymer is so strongly attached to the fibres that it cannot be completely washed away with water and where, if desired, the fibre composition may be recovered. Polymerization of an electrically conductive polymer is hereby carried out in the porous fibres in situ. This is achieved by first absorbing into the porous fibres the monomer to be polymerized and the doping agent of the electrically conductive polymer, and they are allowed to form a salt. After this, a catalyst or an oxidation agent for generating the polymerization reaction is added, causing the doped monomer to be polymerized both inside and upon the fibres. The doped monomer is thereby attached to the fibres.

The method of attaching a conductive polymer to porous fibres is described in more detail in our parallel Finnish patent application “A method of producing a fibre composition”, which was filed on Jan. 4, 2003, and the content of which is incorporated hereby by reference.

By changing the amount of an electrically conductive polymer, the chosen conductivity level is achieved, which is, for instance, 10⁴-10¹¹ ohm/m², typically approximately 10⁴-10⁸ ohm/m². When the resistance per square metre is 10⁸ ohm or lower, the product can easily be separated from the non-conductive product. The conductive network can be integrated in the paper or the cardboard in order to generate the security symbol.

When the electrically conductive polymer is firmly attached to the fibres, for instance already in the headbox of the paper machine, the polymer is uniformly and homogeneously distributed throughout the whole fibre material, too. This is advantageous because a good conductivity is achieved with a smaller quantity of polymer than in the case where the polymer is initially in a dispersed form between the fibres. Even just 10 per cent by weight of polyaniline (of the fibre mass) can generate good electrical conductivity, one which is of magnitude 10⁴ ohm.

Modified cellulose or lignocellulose fibres can be used as such, in other words they can be recovered, dried and mixed with another matrix material, or fibre webs can be formed of slush comprising these fibres, without separation and recovery of fibres.

Electrically conductive cellulose and lignocellulose fibres, according to the present invention, are preferably used for manufacturing electrically conductive paper or cardboard products. After manufacturing, the fibres can be recovered, dried and used in desired applications in dry form or reslushed. Alternatively, the fibres can be transported forward, after processing according to the present invention, to paper or cardboard manufacturing in the form of an aqueous slush and mixed, for example, in the headbox of the paper machine. It is essential that by mixing fibres according to the present invention with such conventional vegetable fibres that do not comprise electrically conductive polymer components, an electrically conductive fibre composition is obtained, one which comprises a uniformly distributed, electrically conductive component. Generally, fibres according to the present invention are added approximately 1-50 per cent by weight of the dry matter of the fibre material, or preferably approximately 2-30 per cent by weight. When a product is manufactured at the paper or the cardboard machine, a fibre matrix is obtained in which the electrically conductive polymer is distributed quite uniformly.

A security product according to the present invention may comprise several fibre layers, at least one of these layers comprising a conductive polymer.

According to the initial form of application of the present invention, a security symbol is created in the fibre layer, which comprises a substrate consisting of porous natural fibres, and has electrically conductive polymers attached onto it. The percentage of the electrically conductive polymers must be sufficient to ensure that the resistance of the layer (surface resistance) is lowered to the level of 10¹¹ ohm, or even lower than that, preferably to the level of 10⁸ ohm, and, if desired, even to the level of 10⁴ ohm. Accordingly, polymer can be added approximately 0.1-150 per cent by weight of the fibre quantity, preferably approximately 1-100 per cent by weight. Preferably, the quantity of the electrically conductive polymer is approximately 5-70%, more preferably approximately 7.5-50%, of the total weight of the fibre material.

In order to get the conductive polymer firmly attached to the fibres, the fibres should consist of porous natural fibres, ones which are in the form of separate and loose fibres, before, as an alternative a coherent fibre matrix is built up of them. First, precursors of polymers—for instance salts formed of monomers and doping agents—are allowed to penetrate into the pores inside the fibres, after which a polymerization reaction takes place, allowing the polymers to become attached to these fibres, both on their surfaces and inside them.

When a fibre matrix, comprising a uniform fibre layer, for instance in paper or cardboard form, is formed of separate and loose fibres for instance at a paper or cardboard machine, a situation is achieved where the electrically conductive polymer has penetrated into the fibres and the main body of the polymer is inside the fibre matrix. As a consequence, the polymer is homogeneously distributed throughout the fibre layer. Here, homogeneous distribution means that the surface resistance of the paper or the cardboard as a function of place varies approximately 10%, at the most.

The grammage of the web formed by the fibre matrix is generally approximately 5-700 g/m², typically approximately 20-500 g/m², for instance approximately 30-150 g/m² with paper, and 80-300 g/m² with cardboard.

A security product can also be formed of a multi-layer product, which comprises a first layer consisting of cellulose or lignocellulose fibres, and a second layer which comprises synthetic, electrically conductive polymer. This second layer can be made from modified fibres or of a web formed of them, as described above. Also, it can consist of a binding agent matrix which the electrically conductive polymer has been mixed with. It is essential that the second layer is at least partly electrically conductive.

The first layer is, above all, the fibre web, but it can also be formed out of the coating layer.

A layered product can be produced for instance by a layer web technique, where a second, electrically conductive layer is formed onto the first layer directly at the headbox. An electrically conductive layer can be formed between two (or more) fibre layers, too.

By mixing the conductive polymer with the binding agent, a desired product can be produced by a conventional laminating technique, as well. The most common procedure is that a homogeneous mixture is first prepared from the binding agent and the conductive polymer. Suitable binding agents are, for instance, starch-based binding agents, dextrines, carboxy-methyl cellulose, polyvinyl alcohol and polyvinyl acetate, to mention some of them.

This kind of a binding agent is used to glue two fibre layers together. These can consist of general fibre webs, such as paper or cardboard webs, but according to a preferable application, the fibre webs are asymmetric paper or cardboard webs. With a solution like this, the rougher surfaces can be glued together and the smoother surfaces can be used as outer surfaces of the product.

A multilayer product can comprise an additional third layer, which is fitted between the first and the second layer. This third layer can consist, for instance, of a plastic film which has been extruded onto the surface of the product, or of a coating material layer.

Fibre laminates comprising conductive polymers, and multilayer products are described in more detail in our parallel Finnish patent application “A multilayer product and its manufacturing method”, which was filed on Jan. 4, 2003, and the content of which is incorporated by reference.

In the product, the layer comprising conductive polymer is in a conductive state within an area that covers at least 0.01% of the total surface area of the product, preferably the percentage of the conductive surface area is approximately 0.1-95% of the total surface area, typically approximately 1-10%.

In the present invention, the porous fibres used for producing the fibre product, including the conductive polymer layer, are cellulose fibres, lignocellulose fibres, cellulose fibres of cereal crops, pentosan of cereal crops, cotton lints, Abaca hemp fibres, sisal fibres, ramie fibres, linen fibres, reed canary grass fibres or jute fibres. When using natural fibres, it is especially preferable to use cellulose or lignocellulose pulp, defibred from annual or perennial plants, such as chemical pulp or mechanical pulp or chemi-mechanical pulp. Among the various chemical cooking processes available are sulphate cooking, continued sulphate cooking, sulphite cooking, polysulphide cooking, organosolv-cookings (for instance Milox cooking) and soda cooking. The most important among the mechanical defibering processes are grinding (GW), pressure grinding (PGW), refining (TMP) and beating (RMP), as well as the chemi-mechanical CTMP and CMP processes. The pulp can be bleached or unbleached.

In the present invention “Electrically conductive polymer” or “Conductive polymer” mean inherently conductive polymers (ICP), which are “doped” (furnished, processed) in order to generate charge carriers (holes and electrons). Common to all electrically conductive polymers are the conjugated double bonds of the backbone chain (alternate single and double bonds, delocalized silicon electron system) which enable the movement of the charge carriers.

Electrically conductive polymers have both ionic and electronic conductivity, which can be utilized in various applications. The conductivity of electrically conductive polymers can fluctuate and be regulated within the whole conductivity range, from insulant to metallic conductor. Generally, a polymer is considered to be electrically conductive if its maximum resistance is 10¹¹ ohm (as surface resistance).

An electrically conductive polymer can be bonded to the fibres, both in an electrically conductive and in an electrically non-conductive form. Consequently, the term “electrically conductive polymer” in the claims presented below also means a polymer that is non-conductive at the time of reference, but which, however, can be brought to an electrically conductive state, for instance by using a suitable doping agent treatment.

Polyaniline, polypyrrolidine, polyacetylene, polyparaphenyl or polytiophene, or derivatives or mixtures of them are used as electrically conductive polymers. Among the derivatives, especially the alkyd and aryl derivatives and the chlorine and bromine-substituted derivatives of the polymers mentioned above, are worth mentioning. If needed, electrically conductive particles, such as graphite or carbon black can be added, too.

Polyaniline is more preferable in the present invention. The monomer in the aniline polymer is aniline or its derivative, the nitrogen atom of which is in most cases bonded to the para-position carbon of the benzene ring of the next unit. The unsubstituted polyaniline can be in different forms, among which the emeraldine state is generally used for conductive polymer applications.

By using doping, the electrically neutral polyaniline can be converted into a conductive polyaniline-complex. The doping agents used in the present invention can vary widely and they are generally employed when doping conjugated polymers into an electrically conductive or semiconductive form.

Such doping agents comprise inorganic or organic acids, and their derivatives, among which mineral acids, sulphonic acids, picric acid, n-nitrobenzene acid, dichloric acetic acid and polymer acids are typical examples. If desired, more than one doping agent can be used.

Preferably, a functional acid is used for doping, such as sulphonic acid, particularly aromatic sulphonic acid, which comprises one aromatic ring, or two merged rings, in which case at least one ring may have a polar or a non-polar cyclic substituent, such as a functional group (for instance a hydroxyl group) or a hydrocarbon chain, such as an alkyl chain with 1-20 carbons. Examples of these are alkyl-benzene sulphonic acids and dialkylbenzene sulphonic acids (where the alkyl comprises 1-20 carbon atoms), other branched benzene sulphonic acids, aromatic diesters of phosphoric acid, etc. Preferred acids are dodecylbenzene sulphonic acid (DBSA), camphor sulphonic acid, para-toluene sulphonic acid and sulphocarbolic acid. With regard to the doping agents, we refer to our parallel patent application “A method of producing ,a fibre composition”.

The amount of doping agents varies according to the amount of monomers. Generally, the amount of monomer is approximately 0.1-200 per cent by weight of the fibre amount, typically approximately 1-150 per cent by weight, preferably approximately 5-120 per cent by weight and more preferably approximately 10-100 per cent by weight. Generally, the amount of compensating ions is equimolar with the amount of monomer, but it can also be approximately the same as the molar amount of the monomer, ±30%.

Usually, the compensating ion (doping agent) is acidic, and when the fibres and the polymer/monomer are brought together, the most suitable pH value of the aqueous phase is clearly acidic, preferably with the pH value below 5, and more preferably above 2. Because pH values that are too low may be disadvantageous to the mechanical properties of the fibres, the preferable pH range is approximately 2-5, more preferably 2-3.

The security product according to the present invention is a paper or a cardboard product, and its grammage may vary between 30 and 500 g/m². It can be coated or uncoated and consist of chemical pulps or mechanical wood-containing pulps. Described above is how the security product can be produced by generating a uniform fibre matrix which comprises conductive polymer. Accordingly, a security symbol is hereby formed in the matrix by processing the polymer with a doping agent or a dedoping agent, among which the simplest examples are normal acids and, correspondingly, alkalis. In this way, the security product is produced, for instance, by first applying a conductive polymer, for example in a non-conducting form, onto the paper, and after that an acidic figure is printed and, as a result, the area below the figure turns conductive. A simple way is to print the desired figure onto the conductive polymer layer, using an acidic material. Because the figure is acidic, it becomes electrically conductive. The figure can be detected and so it can serve as an authenticity guarantee, for instance of a document. The acidic figure to be printed is easily modified, which makes it possible to make an individualised figure comprising a conductive polymer, and a security symbol is formed in the matrix by processing the polymer with a doping or a dedoping agent, among which the simplest examples are normal acids and, correspondingly, alkalis.

In the following, the present invention is described using the enclosed drawings. FIG. 1 shows fibre product 1, for instance a paper or a cardboard sheet, with a layer consisting of an electrically conductive polymer arranged below its surface layer. Thus, the product comprises two layers, 2 and 4, and between them layer 3, which comprises a synthetic conductive polymer. Layer 3 can be completely conductive, or is made locally conductive, for instance inside layer 3 there can be an electrically conductive area in the form of a stripe.

The conductive polymer, i.e. the electrically conductive polymer, typically comprises an inherently conductive polymer, which can be doped in order to generate charge carriers. Thus, according to the case in FIG. 1, the layer comprising an electrically conductive polymer is made locally non-conductive by dedoping the polymer with an alkali solution or, alternatively, locally conductive by doping the polymer with an acidic solution comprising a doping agent.

By using the conductive stripe 3, it is possible to employ a simple measurement to confirm the authenticity of the product. Two electrodes, 5 and 6, are arranged against the layer in order to measure the conductivity of that layer using a voltmeter/ammeter, 7. When measuring in a known direction, i.e. the direction of the conductive stripe (see FIG. 1A), it is possible to measure the conductivity. On the other hand, when measuring perpendicular to the stripe, the layer is not conductive (see FIG. 1B), as indicated by the device, 15.

To simplify the measurement, the paper or the cardboard product can be equipped with a surface figure, 12, which is equivalent to the conductive stripe, 10, below the surface. Thus, the case in FIG. 1B is equivalent to the case in FIG. 1A, except that the conductive polymer layer, 10, in the product layers, 9-11, has been marked on the product surface, 8, for instance with a colour stripe, 12, and, consequently, the point at which the conductivity of the security symbol can be verified is visible from the top of the product.

FIGS. 1A and 1B show how the needle-shaped electrodes, 5, 6 and 13, 14, are used. If the fibre substrate is relatively porous, the electrode points can, if necessary, be pushed through the surface of the product and, consequently, making the measurement of the conductivity more reliable.

In FIGS. 1A and 1B the surface and the middle layers, 2, 4 and 9, 11, respectively, can consist of fibre layers. However, it is also possible to manufacture a product where only the middle layer is of fibre material and covered with two coating material layers.

FIG. 2 shows a printed package, 21, which comprises the surface layer, 22, on which, for instance, the deliverer's trademark, 23, and the directions for use, 24, have been printed. On the surface of the package, two test points, 25 and 28, have been marked. The test points are connected by a conductive stripe below the surface layer—if desired, the whole inner layer of the packing board can be conductive. The test points can be constructed to allow two ways of measuring the conductivity: either such that the conductivity extends up to the surface or that the measurement is carried out by pushing the measuring sensors down to the inner layer of the cardboard. To confirm the authenticity, a simple testing device, 27, can be used, one which measures the conductivity between the test points, 25 and 28. The device will read “OK”, 30, if the product is authentic, and “NO”, 31, if it is not. The result is displayed by leds.

More detailed information about how to carry out the measurement can be given in the directions for use, 24.

FIG. 3 shows the security symbol, 45, which comprises an invisible bar code. The package, 41, is more or less well equivalent to the package in FIG. 2. It comprises a surface layer, 42, the deliverer's logo, 43, and the directions for use, 44.

Only two printed black dots, 46 and 50, are visible on the surface. One of them is connected to the network, 45, which is formed of the conductive polymer. The code is read with a reader, 48, which is lined up using the printed dots. In the present case, the reader has 11 reading sensors, 49. Nine of them are used for coding information, and the largest possible information content to be coded is 9 bits. The reading is carried out by individually measuring the conductivity between the side sensor connected to the figure and each of the nine sensors in the middle. If there is conductivity (and a figure) at the point where the reading sensor is placed, the measuring device gives a conductivity of 1. If there is no conductivity, the reading is 0. In the example shown in the Figure, the code read, 47, is 110110111. Because only one of the side sensors is connected, the code number is verified as correct if the device is turned 180° and if the number remains the same.

The figure, 45, can be connected to a conventional bar code, too, and the shape of the conductive surface can be different. For instance, by using a two-dimensional network, it would be possible to encode much more information into the figure.

FIG. 4 shows the security symbol, 73-75, which comprises binary information. The package, 76, in the Figure is more or less equivalent to the package in FIG. 2. It comprises a surface layer, 77, the deliverer's logo, 71-72, and the directions for use, 78. The binary information formed in the conductive figure can be read capacitively by measuring the capacitance between the middle sensor, 75, and the side sensors, 73. The information is formed by connecting the middle sensor, 75, to the side sensors using conductive lines, 74. The coded information can be written anew by removing the conductivity of the lines, 74, using an alkaline solution, or by restoring it, using an acidic solution. This recoding can be carried out dozens of times.

The printed, conductive figures can have any shape (for instance company logos etc.), and their conductivity can be verified by internal measurement of the figure. Thus, FIG. 5 shows the product, 81, which has on or below its surface security symbols, 82, configured in the form of the company's trademark.

In the cases described above, a layer comprising an electrically conductive polymer can be identified on the basis of its electrical conductivity. Colour differences between conductive and, alternatively, non-conductive polymers can be used for identification, too, if the layer has been fitted to the product in a way which makes it possible to distinguish its colour from outside the product. In addition, changes in the colour and the conductivity of the product can be utilized, as well. By treating the security symbol with a doping agent or, alternatively, a dedoping agent, the electrical conductivity of the polymer, and, at the same time, its colour can often be changed.

If the conductive polymer comprises a polymer that is electrically conductive when it has been doped with an acidic doping agent, a simple way of changing the security symbol is to use an alkaline solution to draw a stripe over the paper or the cardboard. This stripe splits the electrically conductive area and prevents the electricity from flowing between two points.

As described above, the surface of the paper or the cardboard product according to the present invention has a figure indicating that there is a security symbol, which tells the product inspector how the security symbol itself (i.e. its presence) and especially its electrical conductivity can be established. A verification mark such as this can comprise, for instance, two points marked on the surface of the product, such as the dots, 25, 28 and 46, 50, shown in FIG. 2 and 3, respectively. The electrical conductivity between these points forms the security symbol of the product. A sharp-pointed electrode can be used at these points to penetrate the layer below the surface of the paper or the cardboard product.

The figure indicating a security symbol can comprise any text or a graphic symbol of any shape. Besides indicating a security symbol, the figure can indicate the origin, the product description or the directions for using the paper or the cardboard product, or a product which is part of it.

In the method of manufacturing paper- or cardboard-based security products according to the present invention, a layer of an electrically conductive polymer is fitted into the product. The electrical conductivity of this layer is, if desired, locally changed to form an electrically conductive or, alternatively, non-conductive figure, and the paper or the cardboard product surface is equipped with a visual mark indicating a layer comprising an electrically conductive polymer.

The electrical conductivity of a polymer can be changed by doping an electrically non-conductive polymer, or, alternatively, by dedoping an electrically conductive polymer. An electrically non-conductive polymer is doped by treating the polymer layer with an acid solution, and, alternatively, an electrically conductive polymer is dedoped by treating the polymer layer with an alkali solution, which is used to paint a desired figure on the surface of the paper or the cardboard product. In both cases, a desired figure is painted with an acid or, alternatively, an alkali solution on the surface of the paper or the cardboard product. According to an especially interesting alternative, an electrically conductive polymer is doped by printing a desired figure on the surface of the paper or the cardboard product using a printing ink which is capable either of doping or dedoping the electrically conductive polymer.

In acid solutions, the same acids, or different acids can be used as in the doping of conductive polymers (see above). Possible alkalis are conventional hydroxides and carbonates (alkali metal and alkali earth hydroxides and carbonates), and different amines. Typical alkalis are sodium hydroxide, potassium hydroxide and sodium carbonate. Generally, acids and alkalis are used as relatively diluted solutions (approximately as 0.01-5 N, for instance approximately 0.1-1 N solutions), to prevent the fibre matrix from becoming brittle.

When the security symbol has been fitted below the surface layer of the paper or the cardboard product in order to dope, or, alternatively, to dedope the polymer, the acid or, alternatively, the alkali solution will be absorbed through the surface layer of the paper or the cardboard product.

The present invention also generates a method of confirming the authenticity of the security product, which consists of paper or cardboard, and according to the method, paper or cardboard products, which are equipped with an identifiable security symbol, are used as security products.

According to the present invention, a layer is constructed to create a security symbol in the product. This layer consists of a synthetic and electrically conductive polymer, with an electrical conductivity, which has been changed locally to form a figure which is electrically conductive, or, alternatively, electrically non-conductive, and the authenticity of the security product is confirmed by recognising the conductivity of the paper or cardboard product at the point of the security mark.

1. A paper- or a cardboard-based security product which comprises
a paper or a cardboard product which is equipped with a security symbol which can be detected,
characterized in that
the security symbol comprises a layer in the product, which layer consists of a synthetic, electrically conductive polymer, the electrical conductivity of which has been locally changed to form a figure that is electrically conductive or, alternatively, electrically non-conductive, and
the surface of the paper or the cardboard product is provided with a figure which indicates the presence of the security symbol.

2. A product according to claim 1, characterized in that the security symbol comprises a layer that is formed by an electrically conductive polymer that is fitted below the surface layer of the paper or the cardboard product.

3. A product according to claim 1, characterized in that the electrically conductive polymer comprises an independently electrically conductive polymer that can be doped in order to generate charge carriers.

4. A product according to claim 3, characterized in that the layer containing an electrically conductive polymer is rendered locally non-conductive by dedoping the polymer with an alkali solution or, alternatively, locally conductive by doping the polymer with an acid solution containing a doping agent.

5. A product according to claim 1, characterized in that the security symbol comprises a bar code.

6. A product according to claim 1, characterized in that the layer comprising an electrically conductive polymer is identifiable on the basis of its electrical conductivity or the colour of the layer or a combination of these.

7. A product according to claim 6, characterized in that it becomes evident from the figure on the surface of the paper or the cardboard surface how the electrical conductivity of the security symbol can be established.

8. A product according to claim 7, characterized in that by using a figure on the surface of the paper or the cardboard product at least two points have been marked on the surface in such a manner that the electrical conductivity between these two points forms the security symbol of the product.

9. A product according to claim 7, characterized in that the figure comprises text or a graphic symbol.

10. A product according to claim 1, characterized in that the figure, besides indicating the security symbol, also provides the product description or the directions for use of the paper or the cardboard product or a product included in it.

11. A product according to claim 1, characterized in that the electrically conductive polymer is polyaniline, polypyrrolidine or polytiophene.

12. A method of manufacturing a paper- or a cardboard-based security product, according to which method
a paper or a cardboard product is provided with a security symbol which can be detected,
characterized in that
a layer comprising an electrically conductive polymer is fitted in the product,
the electrical conductivity of the electrically conductive polymer in the layer is locally changed to form an electrically conductive or, alternatively, electrically non-conductive figure, and
the paper or the cardboard surface is equipped with a visual mark which indicates the presence of a layer that comprises an electrically conductive polymer.

13. A method according to claim 12, characterized in that the electrical conductivity of the polymer is changed by doping the electrically non-conductive polymer or, alternatively, by dedoping the electrically conductive polymer.

14. A method according to claim 13, characterized in that the electrically non-conductive polymer is doped by treating the polymer layer with an acid solution, which is used to paint a desired figure on the surface of the paper or the cardboard.

15. A method according to claim 13, characterized in that the electrically conductive polymer is dedoped by treating the polymer layer with an alkali solution, which is used to paint a desired figure on the surface of the paper or the cardboard.

16. A method according to claim 13, characterized in that the electrically conductive polymer is doped by printing a desired figure on the surface of the paper or the cardboard using printing ink which is capable either of doping or dedoping the electrically conductive polymer.

17. A method according to claim 12, characterized in that the security symbol comprises a layer fitted below the surface layer of the paper or the cardboard product, said layer being formed by the electrically conductive polymer, in which case, in order to dope or, alternatively, dedope the polymer, an acid or, alternatively, an alkali solution is absorbed through the surface layer of the paper or the cardboard product.

18. A method according to claim 12, characterized in that a figure, from which it becomes evident how the electrical conductivity of the security symbol can be established, is printed on the paper or the cardboard surface.

19. A method according to claim 17, characterized in that on the surface of the paper or the cardboard product a figure is printed in which at least two points have been marked, such that the electrical conductivity between these two points forms the security symbol of the product.

20. A method of confirming the authenticity of a security product, according to which method
a paper or a cardboard product provided with a security symbol, which can be detected, is used as a security product,
characterized in that
a layer comprising a synthetic, electrically conductive polymer, the electrical conductivity of which has been locally changed to form an electrically conductive or, alternatively, non-conductive figure, is formed in the product, and
the authenticity of the security product is confirmed by identifying the electrical conductivity of the paper or the cardboard product at the location of the security symbol.

21. A method according to claim 20, characterized in that a figure indicating the presence of a security symbol is fitted onto the surface of the paper or the cardboard product, said figure showing how to establish the electrical conductivity of the security symbol.

22. A method according to claim 20, characterized in that the electrically conductive polymer is doped by printing a figure on the surface of the paper or the cardboard surface, using printing ink which is capable of doping or dedoping the electrically conductive polymer.

23. A method according to claim 20, characterized in that the authenticity of a paper or a cardboard product is confirmed by treating a security symbol with a doping or dedoping agent and by observing a change in the electrical conductivity of the security symbol.
